(19) United States
(12) Patent Application Publication
(10) Pub. No.: US 2026/0358567 A1
(43) Pub. Date: Nov. 12, 2026

(54) FERRULE ASSEMBLY AND METHOD OF MANUFACTURING OPTICAL CONNECTOR

(71) Applicant: SUMITOMO ELECTRIC OPTIFRONTIER CO., LTD., Yokohama-shi (JP)

(72) Inventors: Ryo ITO, Kanagawa (JP); Masahiro SHIBATA, Kanagawa (JP); Yohei AOSHIMA, Kanagawa (JP)

(73) Assignee: SUMITOMO ELECTRIC OPTIFRONTIER CO., LTD., Yokohama-shi (JP)

(21) Appl. No.: 19/649,977

(22) Filed: Apr. 16, 2026

(30) Foreign Application Priority Data
May 8, 2025 (JP) 2025-077794

(51) Int. Cl. G02B 6/38

(52) U.S. Cl. CPC G02B 6/3834

(57) ABSTRACT

A ferrule assembly according to one embodiment includes a ferrule provided with a first optical fiber insertion hole into which an optical fiber is to be inserted and a diameter-increasing hole aligned with the first optical fiber insertion hole along an insertion direction in which the optical fiber is to be inserted and having an inner diameter larger than an inner diameter of the first optical fiber insertion hole, and a guide pipe inserted into the diameter-increasing hole. The guide pipe has a second optical fiber insertion hole into which the optical fiber to be inserted into the first optical fiber insertion hole is to be inserted, the second optical fiber insertion hole having an inner diameter smaller than the inner diameter of the diameter-increasing hole.

### CROSS REFERENCE TO RELATED APPLICATIONS

This application claims priority based on Japanese Patent Application No. 2025-077794 filed on May 8, 2025, and the entire contents of the Japanese patent application are incorporated herein by reference.

### TECHNICAL FIELD

The present disclosure relates to a ferrule assembly and a method of manufacturing an optical connector.

### BACKGROUND

Patent literature 1(Japanese Unexamined Patent Application Publication No. 2006-337520) describes a method of manufacturing a ferrule with an optical fiber. The ferrule with an optical fiber has a coated optical fiber and a ferrule attached to the leading end of the coated optical fiber. The coated optical fiber includes a single-core fiber in which a primary coating is provided on the outer periphery of a bare optical fiber, and a reinforcing pipe provided on the outer periphery of the single-core fiber. In the method of manufacturing the ferrule with the optical fiber, the front end portion of the single-core fiber is exposed from the end portion of the reinforcing pipe, and the outer peripheral surface of the single-core fiber is adhered to the inner surface of the reinforcing pipe by using the adhesive.

The adhesive forms an adhesive portion that is cured to be raised in a tapered shape from the end portion of the reinforcing pipe toward the leading end of the single-core fiber. Then, the coated optical fiber having the adhesive portion is inserted into the ferrule, and the end portion of the primary coating is abutted against the first tapered hole located between the optical fiber insertion hole and the bare fiber insertion hole. At the same time, the end portion of the reinforcing pipe is abutted against the second tapered hole located between the bare fiber insertion hole and the core wire insertion hole. Further, the optical fiber is adhered to the inside of the ferrule by using the adhesive.

### SUMMARY

A ferrule assembly according to the present disclosure includes a ferrule provided with a first optical fiber insertion hole into which an optical fiber is to be inserted and a diameter-increasing hole aligned with the first optical fiber insertion hole along an insertion direction in which the optical fiber is to be inserted and having an inner diameter larger than an inner diameter of the first optical fiber insertion hole, and a guide pipe inserted into the diameter-increasing hole. The guide pipe has a second optical fiber insertion hole into which the optical fiber to be inserted into the first optical fiber insertion hole is to be inserted, the second optical fiber insertion hole having an inner diameter smaller than the inner diameter of the diameter-increasing hole.

### BRIEF DESCRIPTION OF THE DRAWINGS

FIG. 1 is a side view showing an optical connector including a ferrule assembly according to an embodiment.

FIG. 2 is a front view of the optical connector of FIG. 1.

FIG. 3 is a cross-sectional view taken along line A-A of FIG. 2.

FIG. 4 is a perspective view of a guide pipe of a ferrule assembly according to an embodiment.

FIG. 5 is a perspective view of the optical connector of FIG. 1.

### DETAILED DESCRIPTION

In the ferrule with an optical fiber described above, the inner diameter of the core wire insertion hole, which is a portion into which the reinforcing pipe is inserted, is larger than the outer diameter of the bare optical fiber and is larger than the inner diameter of the optical fiber insertion hole located farther inside from the core wire insertion hole. Thus, it may be difficult to align the position of the optical fiber with the optical fiber insertion hole, and thus there is room for improvement in terms of ease of insertion of the optical fiber. Further, when the optical fiber is inserted into the ferrule, if the optical fiber abuts against the inner surface of the optical fiber insertion hole, the optical fiber may be damaged or disconnection may occur in the optical fiber. In this case, there is a concern that disconnection may occur with the scratch of the optical fiber as a starting point. Thus, it is required to prevent the disconnection of the optical fiber.

The present disclosure aims to provide a ferrule assembly that enables easy insertion of an optical fiber and prevent the disconnection of the optical fiber, as well as a method of manufacturing an optical connector.

According to the present disclosure, the optical fiber can be easily inserted and disconnection of the optical fiber can be prevented.

First, embodiments of a ferrule assembly and a method of manufacturing an optical connector according to the present disclosure will be listed and described. (1) A ferrule assembly according to one embodiment includes a ferrule provided with a first optical fiber insertion hole into which an optical fiber is to be inserted and a diameter-increasing hole aligned with the first optical fiber insertion hole along an insertion direction in which the optical fiber is to be inserted and having an inner diameter larger than an inner diameter of the first optical fiber insertion hole, and a guide pipe inserted into the diameter-increasing hole. The guide pipe has a second optical fiber insertion hole into which the optical fiber to be inserted into the first optical fiber insertion hole is to be inserted, the second optical fiber insertion hole having an inner diameter smaller than the inner diameter of the diameter-increasing hole.

The ferrule assembly includes a ferrule and a guide pipe. The ferrule has a first optical fiber insertion hole into which an optical fiber is to be inserted, and a diameter-increasing hole having an inner diameter larger than the inner diameter of the first optical fiber insertion hole. The guide pipe is inserted into the diameter-increasing hole. The guide pipe has the second optical fiber insertion hole having an inner diameter smaller than the inner diameter of the diameter-increasing hole . The optical fiber inserted into the first optical fiber insertion hole of the ferrule is inserted into the second optical fiber insertion hole. Thus, by inserting the optical fiber into the second optical fiber insertion hole of the guide pipe having an inner diameter smaller than the inner diameter of the diameter-increasing hole, the position of the optical fiber can be easily aligned with the second optical fiber insertion hole. Thus, the optical fiber can be easily inserted into the second optical fiber insertion hole and the first optical fiber insertion hole. Further, since the inner diameter of the second optical fiber insertion hole of the guide pipe is smaller than the inner diameter of the diameter-increasing hole of the ferrule, the abutment of the optical fiber inside the second optical fiber insertion hole can be reduced. Thus, the optical fiber can be made less likely to be damaged, and disconnection of the optical fiber can be prevented.

(2) In the above (1), the guide pipe may be provided with a second tapered hole at an end portion of the second optical fiber insertion hole, the end portion being located in a direction opposite to the insertion direction, the second tapered hole having an inner diameter that increases in the opposite direction. In this case, by forming the second tapered hole at the end portion of the second optical fiber insertion hole in the direction opposite to the insertion direction, the optical fiber can be easily inserted into the second optical fiber insertion hole.

(3) In the above (1) or (2), the ferrule may include a capillary provided with the first optical fiber insertion hole and a flange provided with the diameter-increasing hole. The capillary may be provided with a first tapered hole at an end portion of the first optical fiber insertion hole in a direction opposite to the insertion direction, the first tapered hole having an inner diameter that increases in the opposite direction. In this case, by forming the first tapered hole at the end portion of the capillary in the direction opposite to the insertion direction, the optical fiber can be easily inserted into the first optical fiber insertion hole.

(4) In any one of the above (1) to (3), the guide pipe may be a resin molded component. In this case, since the guide pipe is a resin molded component, burrs do not occur on the guide pipe. Thus, when the optical fiber is inserted into the second optical fiber insertion hole of the guide pipe, contact between the optical fiber and burrs can be avoided. Thus, it is possible to avoid the optical fiber from being damaged or disconnected by the burr.

(5) In any one of the above (1) to (4), the guide pipe may include an inserted portion inserted into the diameter-increasing hole, and a large-diameter portion located in a direction opposite to the insertion direction when viewed from the inserted portion and having an outer diameter larger than the inner diameter of the diameter-increasing hole. In this case, the guide pipe has the large-diameter portion, and thus the guide pipe can be reinforced and can be easily gripped.

(6) A method of manufacturing an optical connector according to one embodiment is a method of manufacturing an optical connector including the ferrule assembly and an optical fiber. The manufacturing method includes inserting the guide pipe into the diameter-increasing hole of the ferrule, and after inserting the guide pipe into the diameter-increasing hole, inserting the optical fiber into the second optical fiber insertion hole of the guide pipe and the first optical fiber insertion hole of the ferrule.

In the method of manufacturing the optical connector, the guide pipe is inserted into the diameter-increasing hole of the ferrule, and the optical fiber to be inserted into the first optical fiber insertion hole of the ferrule is inserted into the second optical fiber insertion hole of the guide pipe. Thus, as in the ferrule assembly described above, by inserting the optical fiber into the second optical fiber insertion hole of the guide pipe having an inner diameter smaller than the inner diameter of the diameter-increasing hole, the position of the optical fiber can be easily aligned with the second optical fiber insertion hole. Thus, the optical fiber can be easily inserted into the second optical fiber insertion hole and the first optical fiber insertion hole, and the abutment of the optical fiber inside the second optical fiber insertion hole can be reduced. Thus, the optical fiber can be made less likely to be damaged, and disconnection of the optical fiber can be prevented.

Specific examples of a ferrule assembly and a method of manufacturing an optical connector according to embodiments of the present disclosure will be described below with reference to the drawings. In the description of the drawings, the same or corresponding elements are denoted by the same reference numerals, and redundant description will be omitted as appropriate. In the drawings, some parts may be simplified or exaggerated for easy understanding, and the dimensional ratios and the like are not limited to those shown in the drawings.

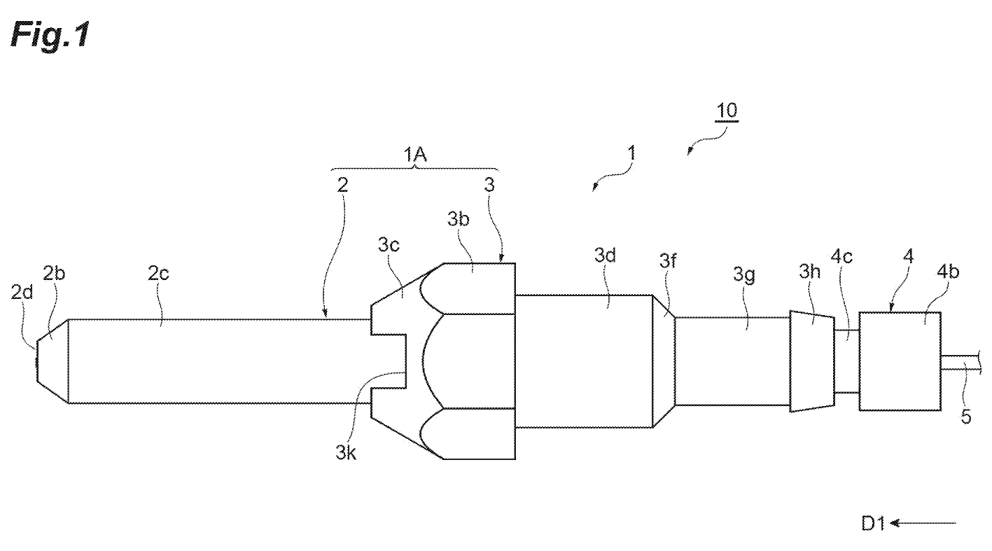

FIG. 1 is a side view showing an optical connector 10 including a ferrule assembly 1 as an example of an embodiment. As shown in FIG. 1, the optical connector 10 includes the ferrule assembly 1 and an optical fiber 5 held by the ferrule assembly 1. The ferrule assembly 1 has a ferrule 1A and a guide pipe 4 inserted into the ferrule 1A. The ferrule 1A includes a capillary 2 and a flange 3.

The guide pipe 4 is inserted into the ferrule 1A along an insertion direction D1, and the optical fiber 5 is inserted into the guide pipe 4 along the insertion direction D1. For example, the direction in which the guide pipe 4 is inserted into the ferrule 1A and the direction in which the optical fiber 5 is inserted into the guide pipe 4 are the same. The insertion direction D1 is a direction in which the ferrule 1A is provided when viewed from the guide pipe 4.

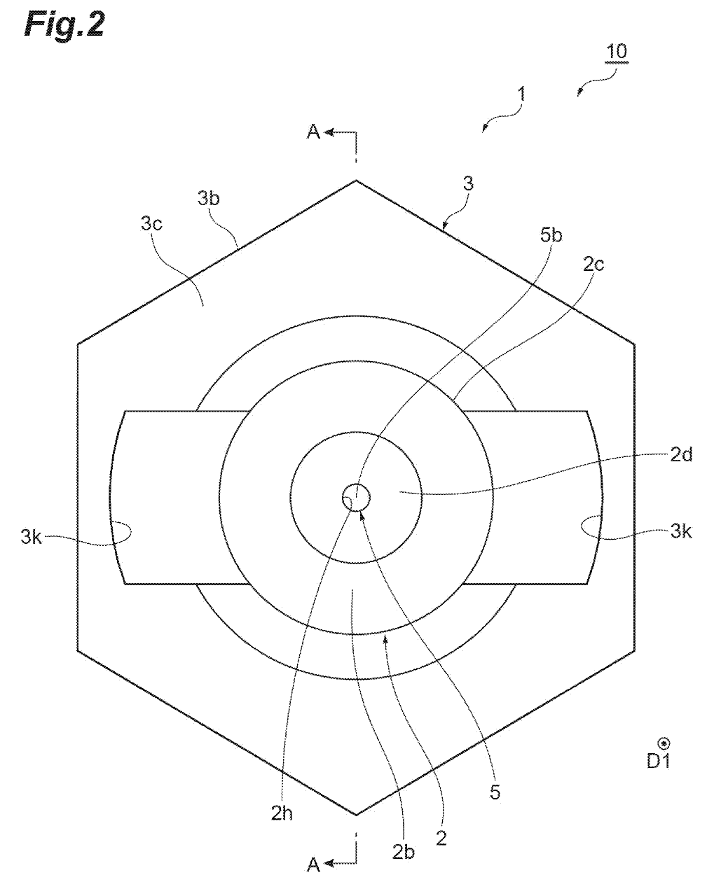

FIG. 2 is a front view of the optical connector 10 as viewed along a direction opposite to the insertion direction D1. As shown in FIGS. 1 and 2, the capillary 2 has an end surface 2d located at an end portion of the capillary 2 in the insertion direction D1, a side surface 2c which is a portion extending from the flange 3 in the insertion direction D1, and an inclined surface 2b extending from the side surface 2c to the end surface 2d. For example, the capillary 2 is a columnar shape , and the outer diameter of the inclined surface 2b decreases from the side surface 2c to the end surface 2d. The end surface 2d has an opening 2h through which a distal end surface 5b of the optical fiber 5 is exposed. The capillary 2 is made of, for example, ceramic such as zirconia, glass, or metal.

The flange 3 has, for example, a stepped cylindrical shape. The flange 3 has, for example, a nut-like portion 3b, an inclined surface 3c that is a portion where the diameter of the flange 3 decreases from the nut-like portion 3b to the insertion direction D1, and a recessed portion 3k that is recessed from an end portion of the flange 3 in the insertion direction D1 in a direction opposite to the insertion direction D1. When the flange 3 is viewed along the direction opposite to the insertion direction D1, the nut-like portion 3b has a hexagonal shape. The flange 3 has a pair of recessed portions 3k, and the pair of recessed portions 3k are arranged at positions sandwiching the capillary 2.

The flange 3 has a first tubular portion 3d extending from the nut-like portion 3b in a direction opposite to the insertion direction D1, and a second tubular portion 3g located in the opposite direction from the first tubular portion 3d and thinner than the first tubular portion 3d. Further, the flange 3 has an inclined surface 3f which is a portion in which the outer diameter decreases from the first tubular portion 3d to the second tubular portion 3g, and a large-diameter portion 3h located at an end portion of the second tubular portion 3g in a direction opposite to the insertion direction D1. The flange 3 is made of, for example, metal. However, the flange 3 may be made of resin, and the material of the flange 3 is not particularly limited.

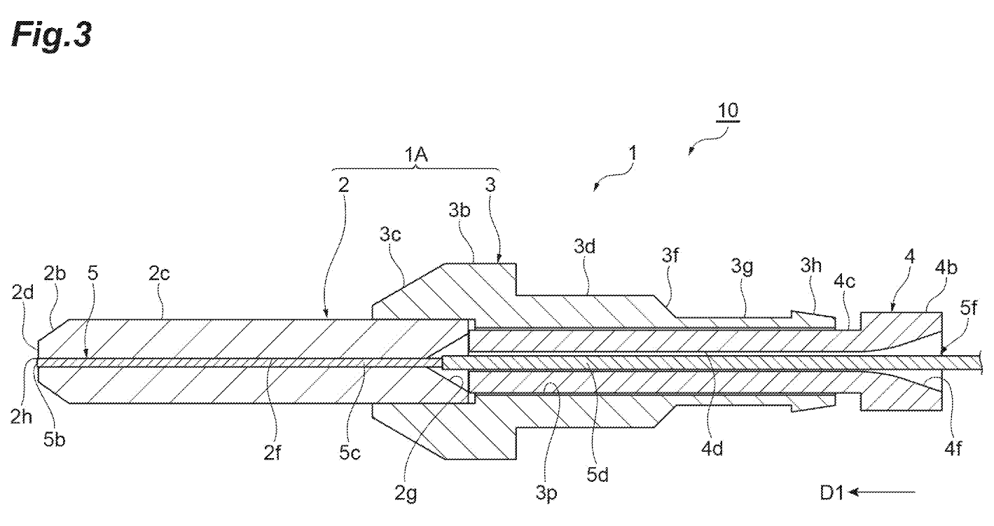

FIG. 3 is a cross-sectional view taken along line A-A of FIG. 2. As shown in FIG. 3, the ferrule 1A has a first optical fiber insertion hole 2f into which the optical fiber 5 is inserted, and a diameter-increasing hole 3p aligned with the first optical fiber insertion hole 2f along the insertion direction D1. For example, the capillary 2 is provided with the first optical fiber insertion hole 2f, and the flange 3 provided with the diameter-increasing hole 3p. The inner diameter of the diameter-increasing hole 3p is larger than the inner diameter of the first optical fiber insertion hole 2f. The diameter-increasing hole 3p is located in a direction opposite to the insertion direction D1 of the first optical fiber insertion hole 2f.

The optical fiber 5 has a bare fiber 5c and a coating 5d covering the bare fiber 5c. At the end portion of the insertion direction D1 of the optical fiber 5, the coating 5d is stripped off and the bare fiber 5c is exposed. The bare fiber 5c is inserted into the first optical fiber insertion hole 2f. The coating 5d is not inserted into the first optical fiber insertion hole 2f. For example, the outer diameter of the bare fiber 5c is 125.0 μm, and the inner diameter of the first optical fiber insertion hole 2f is larger than 125.0 μm. For example, the inner diameter of the first optical fiber insertion hole 2f is 126.5 μm.

The capillary 2 has a first tapered hole 2g located at an end portion of the first optical fiber insertion hole 2f in a direction opposite to the insertion direction D1. The inner diameter of the first tapered hole 2g increases as the distance from the first optical fiber insertion hole 2f increases. That is, the inner diameter of the first tapered hole 2g increases in the direction opposite to the insertion direction D1. For example, an end portion of the coating 5d in the insertion direction D1 is located in the first tapered hole 2g.

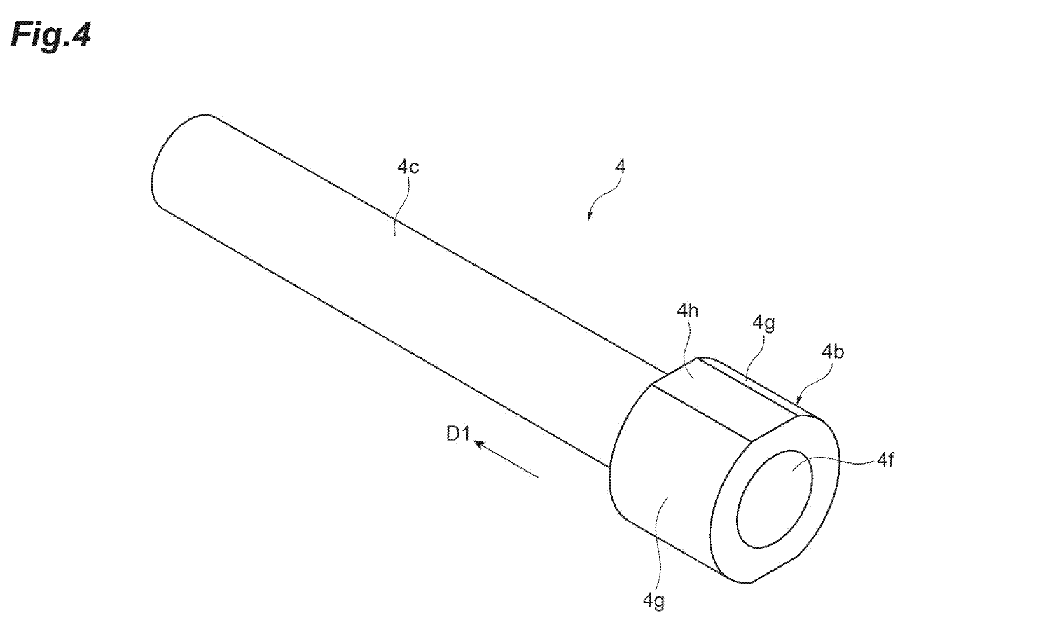

The guide pipe 4 is inserted into the diameter-increasing hole 3p. FIG. 4 is a perspective view showing the guide pipe 4. As shown in FIG. 3 and FIG. 4, the guide pipe 4 includes an inserted portion 4c inserted into the diameter-increasing hole 3p, and a large-diameter portion 4b located in a direction opposite to the insertion direction D1 when viewed from the inserted portion 4c. The guide pipe 4 is provided to guide the optical fiber 5 to the first optical fiber insertion hole 2f.

The guide pipe 4 does not directly insert the optical fiber 5 into the diameter-increasing hole 3p, but inserts the optical fiber 5 into the first optical fiber insertion hole 2f after passing the optical fiber 5 through the inside of the guide pipe 4. The guide pipe 4 is inserted into the diameter-increasing hole 3p of the ferrule 1A before the optical fiber 5 is inserted into the guide pipe 4. The large-diameter portion 4b and the inserted portion 4c are, for example, cylindrical shape. The outer diameter of the large-diameter portion 4b is, for example, larger than the inner diameter of the ferrule 1A (for example, the flange 3). As an example, the outer diameter of the large-diameter portion 4b is 1.6 mm, and the length of the insertion direction D1 of the large-diameter portion 4b is 1.2 mm.

The outer diameter of the large-diameter portion 4b is larger than the inner diameter of the diameter-increasing hole 3p. Thus, the large-diameter portion 4b is not inserted into the diameter-increasing hole 3p. The large-diameter portion 4b has, for example, a curved surface portion 4g and a flat surface portion 4h. Thus, the large-diameter portion 4b is shaped to be easily gripped by a finger. The large-diameter portion 4b has, for example, the plurality of curved surface portions 4g and the plurality of flat surface portions 4h. The curved surface portion 4g and the flat surface portion 4h are alternately aligned along the circumferential direction, which is the direction around the axis of the guide pipe 4.

The guide pipe 4 has a second optical fiber insertion hole 4d having an inner diameter smaller than the inner diameter of the diameter-increasing hole 3p. The second optical fiber insertion hole 4d is a hole into which the optical fiber 5 to be inserted into the first optical fiber insertion hole 2f is to be inserted . For example, the coating 5d of the optical fiber 5 is inserted into the second optical fiber insertion hole 4d. The optical fiber 5 has, for example, a marker 5f for aligning the position of the optical fiber 5 with respect to the guide pipe 4. The optical fiber 5 is inserted into the second optical fiber insertion hole 4d and the first optical fiber insertion hole 2f so that the position of the marker 5f is aligned with the position of the end portion of the guide pipe 4 in the direction opposite to the insertion direction D1.

The outer diameter of the inserted portion 4c of the guide pipe 4 is, for example, 0.9 mm, and the inner diameter of the diameter-increasing hole 3p is larger than 0.9 mm. As an example, the inner diameter of the diameter-increasing hole 3p is 1.0 mm. For example, the outer diameter of the coating 5d is 250 μm, and the inner diameter of the second optical fiber insertion hole 4d is larger than 250 μm. As an example, the inner diameter of the second optical fiber insertion hole 4d is 300 μm to 400 μm .

The guide pipe 4 has a second tapered hole 4f located at an end portion of the second optical fiber insertion hole 4d in a direction opposite to the insertion direction D1. The inner diameter of the second tapered hole 4f increases as the distance from the second optical fiber insertion hole 4d increases. The inner diameter of the second tapered hole 4f increases in the direction opposite to the insertion direction D1. The second tapered hole 4f is formed in, for example, the large-diameter portion 4b. In this case, since it is possible to avoid the occurrence of a thin portion in the guide pipe 4, it is possible to maintain the strength of the guide pipe 4. The guide pipe 4 is, for example, a resin molded component. In this case, the guide pipe 4 can be easily produced by resin molding.

An example of a method of manufacturing an optical connector according to the embodiment will be described. An example of a method for manufacturing the optical connector 10 will be described below. First, the capillary 2 is assembled to the flange 3 to produce the ferrule 1A (a step of producing a ferrule). Next, an adhesive is injected into the diameter-increasing hole 3p of the ferrule 1A (a step of injecting an adhesive).

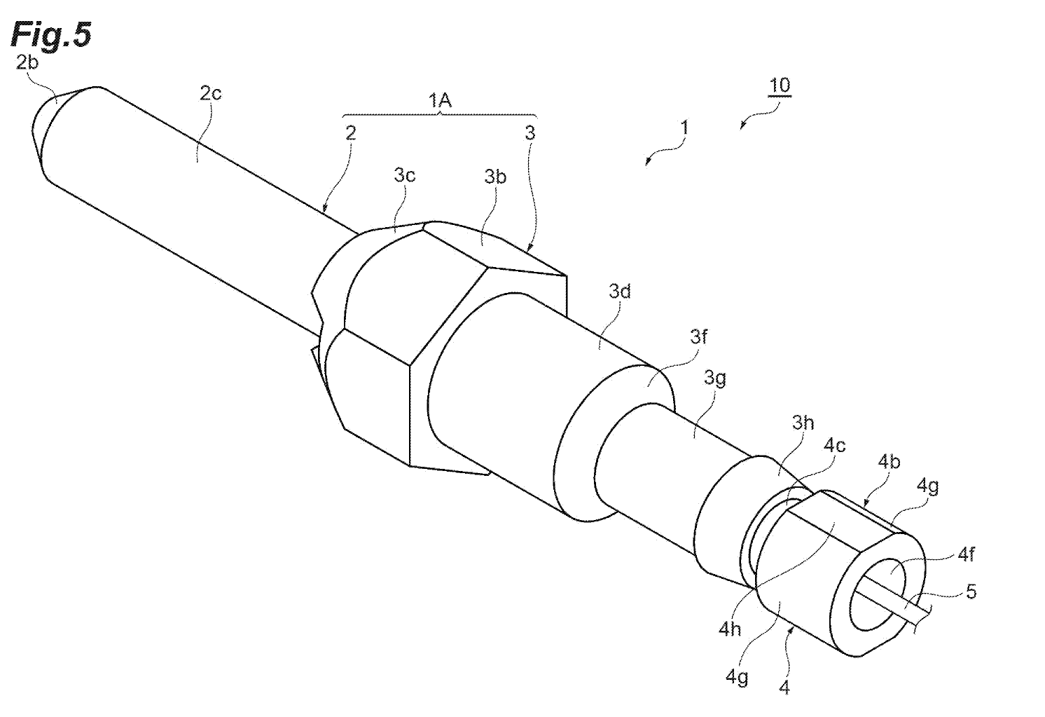

As shown in FIGS. 3 and 5, the guide pipe 4 is inserted into the diameter-increasing hole 3p of the ferrule 1A (a step of inserting the guide pipe). At this time, the inserted portion 4c of the guide pipe 4 is inserted into the diameter-increasing hole 3p along the insertion direction D1. Further, the coating 5d of the end portion of the optical fiber 5 is stripped off to expose the bare fiber 5c at the end portion of the optical fiber 5. The length of the exposed bare fiber 5c is slightly longer than the length of the first optical fiber insertion hole 2f in the insertion direction D1. Then, after the guide pipe 4 is inserted into the diameter-increasing hole 3p as described above, the optical fiber 5 is inserted into the second optical fiber insertion hole 4d of the guide pipe 4 and the first optical fiber insertion hole 2f of the ferrule 1A (a step of inserting an optical fiber).

At this time, the bare fiber 5c of the optical fiber 5 is inserted into the second optical fiber insertion hole 4d and the first optical fiber insertion hole 2f, and the coating 5d of the optical fiber 5 is inserted into the second optical fiber insertion hole 4d. The optical fiber 5 is inserted until the position of the marker 5f is aligned with the position of the end portion of the guide pipe 4 in the direction opposite to the insertion direction D1. As the optical fiber 5 is inserted, the adhesive spreads inside the second optical fiber insertion hole 4d and inside the first optical fiber insertion hole 2f, the coating 5d adheres to the inner surface of the second optical fiber insertion hole 4d, and the bare fiber 5c adheres to the inner surface of the first optical fiber insertion hole 2f.

After the optical fiber 5 is inserted, the adhesive is cured (a step of curing the adhesive). For example, the adhesive is a thermosetting adhesive. In this case, the adhesive is cured by placing the metal flange 3 on the heat plate and transferring the heat of the heat plate to the adhesive. After the adhesive is cured, the bare fiber 5c protruding from the opening 2h is cut, and the end surface 2d of the ferrule 1A is polished (a polishing step). The manufacture of the optical connector 10 is completed through the above steps.

Effects obtained from the ferrule assembly 1 and the method of manufacturing the optical connector 10 according to the embodiment will be described. The ferrule assembly 1 and the method of manufacturing the optical connector 10 according to the embodiment include the ferrule 1A and the guide pipe 4. The ferrule 1A has the first optical fiber insertion hole 2f into which the optical fiber 5 is to be inserted, and the diameter-increasing hole 3p having an inner diameter larger than the inner diameter of the first optical fiber insertion hole 2f. The guide pipe 4 is inserted into the diameter-increasing hole 3p. The guide pipe 4 has the second optical fiber insertion hole 4d having an inner diameter smaller than the inner diameter of the diameter-increasing hole 3p. The optical fiber 5 inserted into the first optical fiber insertion hole 2f of the ferrule 1A is inserted into the second optical fiber insertion hole 4d. Thus, by inserting the optical fiber 5 into the second optical fiber insertion hole 4d of the guide pipe 4 having an inner diameter smaller than the inner diameter of the diameter-increasing hole 3p, the position of the optical fiber 5 can be easily aligned with the second optical fiber insertion hole 4d. Thus, the optical fiber 5 can be easily inserted into the second optical fiber insertion hole 4d and the first optical fiber insertion hole 2f. Furthermore, since the inner diameter of the second optical fiber insertion hole 4d of the guide pipe 4 is smaller than the inner diameter of the diameter-increasing hole 3p of the ferrule 1A, the abutment of the optical fiber 5 inside the second optical fiber insertion hole 4d can be reduced. Thus, the optical fiber 5 can be made less likely to be damaged, and disconnection of the optical fiber 5 can be prevented.

The guide pipe 4 may be provided with the second tapered hole 4f at an end portion of the second optical fiber insertion hole 4d in a direction opposite to the insertion direction D1, and the second tapered hole 4f has an inner diameter that increases in the opposite direction. In this case, by forming the second tapered hole 4f at the end portion of the second optical fiber insertion hole 4d in the direction opposite to the insertion direction D1, the optical fiber 5 can be easily inserted into the second optical fiber insertion hole 4d.

The ferrule 1A may include the capillary 2 provided with the first optical fiber insertion hole 2f and the flange 3 provided with the diameter-increasing hole 3p. The capillary 2 may be provided with the first tapered hole 2g at an end portion of the first optical fiber insertion hole 2f in a direction opposite to the insertion direction D1, and the first tapered hole 2g has an inner diameter that increases in the opposite direction. In this case, by forming the first tapered hole 2g at the end portion of the capillary 2 in the direction opposite to the insertion direction D1, the optical fiber 5 can be easily inserted into the first optical fiber insertion hole 2f. Further, abutment of the optical fiber 5 (for example, the coating 5d) can be avoided.

The guide pipe 4 may be a resin molded component. In this case, since the guide pipe 4 is a resin molded component, burrs do not occur on the guide pipe 4. Thus, when the optical fiber 5 is inserted into the second optical fiber insertion hole 4d of the guide pipe 4, contact between the optical fiber 5 and burrs can be avoided. Thus, it is possible to avoid the optical fiber 5 from being damaged or disconnected by the burr.

The guide pipe 4 may include the inserted portion 4c inserted into the diameter-increasing hole 3p, and the large-diameter portion 4b located in a direction opposite to the insertion direction D1 when viewed from the inserted portion 4c and having an outer diameter larger than the inner diameter of the diameter-increasing hole 3p. In this case, the guide pipe 4 has the large-diameter portion 4b, and thus the guide pipe 4 can be reinforced and the guide pipe 4 can be easily gripped.

The ferrule assembly and the method of manufacturing an optical connector according to the present disclosure have been described above. However, the ferrule assembly and the method of manufacturing an optical connector according to the present disclosure are not limited to the contents of the above embodiments, and may be modified within the scope of the gist described in the claims. That is, the shape, size, material, number, and arrangement of the respective parts of the ferrule assembly according to the present disclosure, and the contents and order of the steps of the method of manufacturing the optical connector can be appropriately changed within the scope of the above gist.

It should be understood that at least one configuration or feature described in each embodiment and example of the present disclosure can be combined with other embodiments or examples or can be modified in various ways. For example, in the above embodiment, the ferrule assembly 1 including the guide pipe 4 having the large-diameter portion 4b has been described. However, the ferrule assembly may include a guide pipe that does not have the large-diameter portion 4b.

What is claimed is:

1. A ferrule assembly comprising:
a ferrule provided with a first optical fiber insertion hole into which an optical fiber is to be inserted and a diameter-increasing hole aligned with the first optical fiber insertion hole along an insertion direction in which the optical fiber is to be inserted and having an inner diameter larger than an inner diameter of the first optical fiber insertion hole; and
a guide pipe inserted into the diameter-increasing hole,
wherein the guide pipe has a second optical fiber insertion hole into which the optical fiber to be inserted into the first optical fiber insertion hole is to be inserted, the second optical fiber insertion hole having an inner diameter smaller than the inner diameter of the diameter-increasing hole.

2. The ferrule assembly according to claim 1,
wherein the guide pipe is provided with a second tapered hole at an end portion of the second optical fiber insertion hole, the end portion being located in a direction opposite to the insertion direction , the second tapered hole having an inner diameter that increases in the opposite direction.

3. The ferrule assembly according to claim 1,
wherein the ferrule includes a capillary provided with the first optical fiber insertion hole and a flange provided with the diameter-increasing hole, and
wherein the capillary is provided with a first tapered hole at an end portion of the first optical fiber insertion hole in a direction opposite to the insertion direction, the first tapered hole having an inner diameter that increases in the opposite direction.

4. The ferrule assembly according to claim 1,
wherein the guide pipe is a resin molded component.

5. The ferrule assembly according to claim 1,
wherein the guide pipe comprises:
an inserted portion inserted into the diameter-increasing hole; and
a large-diameter portion located in a direction opposite to the insertion direction when viewed from the inserted portion and having an outer diameter larger than the inner diameter of the diameter-increasing hole.

6. A method of manufacturing an optical connector including the ferrule assembly according to claim 1 and an optical fiber, the method comprising:
inserting the guide pipe into the diameter-increasing hole of the ferrule; and
after inserting the guide pipe into the diameter-increasing hole, inserting the optical fiber into the second optical fiber insertion hole of the guide pipe and the first optical fiber insertion hole of the ferrule.
